(19) United States
(12) Patent Application Publication
(10) Pub. No.: US 2017/0229743 A1
(43) Pub. Date: Aug. 10, 2017

(54) NONAQUEOUS ELECTROLYTE SECONDARY BATTERY

(71) Applicant: TOYOTA JIDOSHA KABUSHIKI KAISHA, Toyota-shi, Aichi-ken (JP)

(72) Inventor: Yuichi ITO, Nissin-shi, Aichi-ken (JP)

(73) Assignee: TOYOTA JIDOSHA KABUSHIKI KAISHA, Toyota-shi, Aichi-ken (JP)

(21) Appl. No.: 15/501,272

(22) PCT Filed: Aug. 3, 2015
(86) PCT No.: PCT/IB2015/001298

§ 371 Date: Feb. 2, 2017

(30) Foreign Application Priority Data
Aug. 6, 2014 (JP) 2014-160126

(51) Int. Cl. H01M 10/42; H01M 2/16; H01M 10/0567; H01M 2/34

(52) U.S. Cl. CPC H01M 10/4235; H01M 2/345; H01M 2/1686; H01M 10/0567; H01M 2200/20; H01M 2300/0025

(57) ABSTRACT

A nonaqueous electrolyte secondary battery includes an electrode body 80 in which a positive electrode (10) and a negative electrode (20) are disposed to be opposite to each other with a separator (40) interposed between the positive electrode and the negative electrode; a nonaqueous electrolyte; and a battery case that accommodates the electrode body and the nonaqueous electrolyte. The battery case includes a current interrupt device that operates in response to an increase in an internal pressure of the battery case. The nonaqueous electrolyte contains a fluorine-containing compound and a gas producing agent. The separator (40) includes a hydrofluoric acid trapping layer (44) containing an inorganic phosphate compound on a surface of the separator.

### BACKGROUND OF THE INVENTION

1. Field of the Invention

The present invention relates to a nonaqueous electrolyte secondary battery. Specifically, the invention relates to a nonaqueous electrolyte secondary battery including a current interrupt device which operates in response to an increase in the internal pressure of a battery.

2. Description of Related Art

Typically, a nonaqueous electrolyte secondary battery such as a lithium ion secondary battery is used in a state where the voltage is controlled to be in a predetermined region (for example, 3.0 V to 4.2 V). However, when an excessively high current is supplied to the battery due to malfunction or the like, the battery may be overcharged to higher than a predetermined voltage. When the overcharge progresses, for example, the internal temperature of the battery may increase due to heat generation of an active material, or the battery may be swollen due to gas produced by the decomposition of a nonaqueous electrolyte. Due to these problems, the progress of the overcharge is not preferable. Therefore, in order to prevent these problems, a configuration is widely used, in which a battery case includes a pressure-operated current interrupt device (CID), and a nonaqueous electrolyte contains a compound (hereinafter, also referred to as “gas producing agent”) which is decomposed to produces gas during the overcharge of a battery (refer to Japanese Patent Application Publication No. 2014-082098 (JP 2014-082098 A). When a battery having this configuration is overcharged, the gas producing agent reacts on a positive electrode to produce hydrogen ions, and hydrogen gas (H₂) is produced from the hydrogen ions on a negative electrode. Due to this hydrogen gas, the internal pressure of a battery case rapidly increases. Therefore, the charging current to the battery can be interrupted in an early stage of overcharge, and the progress of overcharge can be stopped.

However, according to the investigation, the present inventors found that the above-described technique has room for further improvement. That is, it was found that, after the battery is exposed to severe conditions for a long period of time (for example, after the battery is stored or used in a high-temperature environment of 50° C. or higher for a long period of time), the reactivity of the gas producing agent during overcharge decreases; as a result, the production of hydrogen gas may be slowed, or the amount of hydrogen gas produced may decrease. In this case, the time required to operate the current interrupt device may increase, and overcharge resistance is likely to decrease.

### SUMMARY OF THE INVENTION

The present invention provides a nonaqueous electrolyte secondary battery including a current interrupt device (pressure-operated type) that operates in response to an increase in the internal pressure of a battery, in which overcharge resistance is superior even when being exposed to severe conditions (for example, a high-temperature environment of 50° C. or higher) for a long period of time.

The present inventors investigated the reason for a decrease in the reactivity of a gas producing agent from various aspects. As a result, it was found that, even when a battery is exposed to the above-described severe condition for a long period of time, a fluorine-containing compound (for example, LiPF₆ as a supporting electrolyte) contained in a nonaqueous electrolyte is gradually decomposed (typically, being reduced and decomposed on a negative electrode) and hydrofluoric acid is produced. By hydrofluoric acid being deposited on a surface of a positive electrode as a film (fluorine-containing film) containing fluorine, the reaction of a gas producing agent during overcharge may be inhibited, and hydrogen gas is not likely to be produced.

In order to suppress the above-described production of a fluorine-containing film on a surface of a positive electrode, as a result of further thorough investigation, the present inventors completed the invention. According to an aspect of the invention, a nonaqueous electrolyte secondary battery includes: an electrode body in which a positive electrode and a negative electrode are disposed to be opposite to each other with a separator interposed between the positive electrode and the negative electrode; a nonaqueous electrolyte; and a battery case that accommodates the electrode body and the nonaqueous electrolyte. The battery case includes a current interrupt device(CID) that operates in response to an increase in an internal pressure of the battery case. The nonaqueous electrolyte at least contains a fluorine-containing compound and a gas producing agent, and the separator includes a hydrofluoric acid trapping layer containing an inorganic phosphate compound on a surface of the separator.

In the battery having the above-described configuration, the hydrofluoric acid trapping layer can trap (or consume) hydrofluoric acid produced by the decomposition of the fluorine-containing compound. Therefore, even under severe conditions (for example, in a high-temperature environment of about 50° C. to 70° C.), the production of a fluorine-containing film on the surface of the positive electrode can be suppressed. Accordingly, the reaction field of the gas producing agent (contact area between the gas producing agent and the surface of the positive electrode) can be widely secured. As a result, the gas producing agent can be oxidized and decomposed at once during overcharge, and hydrogen gas can be rapidly produced therefrom. That is, even when being exposed to severe conditions for a long period of time, a nonaqueous electrolyte secondary battery having high overcharge resistance (reliability) can be realized. In this specification, “fluorine-containing compound” refers to all the compounds containing at least one fluorine atom as a constituent atom. In addition, when being ionized (H⁺F⁻) in a nonaqueous electrolytic solution, the fluorine-containing compound can be present in the form of a fluoride ion.

Japanese Patent Application Publication No. 2009-146610 (JP 2009-146610 A) describes a buffer layer including an organic compound and an inorganic compound on a surface of a separator substrate, in which the buffer layer functions as a superior cushioning material so as to avoid and suppress a rapid shrinkage or rupture of a separator. In addition, Japanese Patent Application Publication No. 2014-103098 (JP 2014-103098 A) describes that battery deterioration can be suppressed by a positive electrode active material layer containing an inorganic phosphate. However, these patent documents have no descriptions regarding a current interrupt device or a gas producing agent and thus do not deal with the object of the invention. The technique disclosed herein is clearly distinguished from the technical ideas of the techniques in the related art.

In the nonaqueous electrolyte secondary battery, the separator may include the hydrofluoric acid trapping layer on a surface on a side opposite the positive electrode. According to the investigation by the present inventors, by disposing the hydrofluoric acid trapping layer at a position near the positive electrode (typically in contact with the positive electrode), the hydrofluoric acid trapping ability of the hydrofluoric acid trapping layer can be improved, and the effects of the invention can be exhibited at a higher level.

In the nonaqueous electrolyte secondary battery, in the separator, a porous heat resistance layer may be laminated on a surface of a separator substrate, and the hydrofluoric acid trapping layer may be laminated on a surface of the porous heat resistance layer.

In the nonaqueous electrolyte secondary battery, a ratio of the mass of the inorganic phosphate compound to the total mass of the hydrofluoric acid trapping layer may be 70 mass % to 99 mass %.

In the nonaqueous electrolyte secondary battery, a ratio of the mass of a binder to the total mass of the hydrofluoric acid trapping layer may be 1 mass % to 20 mass %.

In the nonaqueous electrolyte secondary battery, the positive electrode may contain a positive electrode active material, and a content of the inorganic phosphate compound may be 1 part by mass or more with respect to 100 parts by mass of the mass of the positive electrode active material. As a result, hydrofluoric acid can be more stably trapped, and the effects of the invention can be exhibited at a higher level. In addition, in another aspect, the content of the inorganic phosphate compound is 5 parts by mass or less with respect to 100 parts by mass of the mass of the positive electrode active material. As a result, the battery resistance can be maintained to be low, and superior battery performance can be exhibited during normal use. In other words, battery characteristics (for example, input and output characteristics) during normal use and overcharge resistance can be simultaneously realized at a high level.

As the inorganic phosphate compound, for example, a phosphate containing an alkali metal element or a Group 2 element can be adopted. Specifically, for example, Li₃PO₄, Na₃PO₄, K₃PO₄, Mg₃(PO₄)₂, or Ca₃(PO₄)₂ can be adopted. Among these, a compound (for example, lithium phosphate (for example, in a lithium ion secondary battery, Li₃PO₄ (LPO))) having the same cation (charge carrying ion) as that of a supporting electrolyte may also be used.

In the nonaqueous electrolyte secondary battery, an average particle size of the inorganic phosphate compound may be 10 μm or less.

### BRIEF DESCRIPTION OF THE DRAWINGS

Features, advantages, and the technical and industrial significance of exemplary embodiments of the invention will be described below with reference to the accompanying drawings, in which like numerals denote like elements, and wherein:

FIG. 1 is a graph showing a relationship between the amount of gas produced during overcharge and the fluoride ion content of a positive electrode, after a predetermined period of storage in a high-temperature environment of 60° C.;

FIG. 2 is a vertical cross-sectional view schematically showing a nonaqueous electrolyte secondary battery according to an embodiment of the invention;

FIG. 3 is a schematic view showing a configuration of a wound electrode body of FIG. 2;

FIG. 4 is a cross-sectional view taken alone line IV-IV of the wound electrode body of FIG. 3;

FIG. 5A is a graph showing battery characteristics after being subjected to high-temperature storage, in which the amount of gas produced during overcharge and the fluoride ion content of a positive electrode are shown;

FIG. 5B is a graph showing battery characteristics after being subjected to high-temperature storage, in which the battery resistance is shown; and

FIG. 6 is a graph showing a relationship between the addition amount of lithium phosphate, the amount of gas produced during overcharge, and the resistance increase rate.

### DETAILED DESCRIPTION OF EMBODIMENTS

Preferred embodiments of the invention are described below. Matters (for example, a general manufacturing process of a battery which is not a characteristic of the invention) necessary to practice this invention other than those specifically referred to in this specification may be understood as design matters based on the related art in the pertinent field for a person of ordinary skills in the art. The invention can be practiced based on the contents disclosed in this specification and common technical knowledge in the subject field.

A nonaqueous electrolyte secondary battery disclosed herein includes: an electrode body in which a positive electrode and a negative electrode are disposed to be opposite each other with a separator interposed between the positive electrode and the negative electrode; a nonaqueous electrolyte; and a battery case that accommodates the electrode body and the nonaqueous electrolyte. Hereinafter, the respective components will be sequentially described.

[Positive Electrode]

Typically, the positive electrode of the battery disclosed herein includes: a positive electrode current collector; and a positive electrode active material layer that contains a positive electrode active material attached to the positive electrode current collector. As the positive electrode current collector, a conductive member formed of highly conductive metal (for example, aluminum, nickel, or titanium) is preferably used. The positive electrode active material layer includes at least a positive electrode active material. As the positive electrode active material, one kind or two or more kinds may be used among various materials which can be used as a positive electrode active material of a nonaqueous electrolyte secondary battery. Preferable examples of the positive electrode active material include layered or spinel type lithium transition metal composite oxide materials (for example, LiNiO₂, LiCoO₂, LiMn₂O₄, LiFeO₂, LiNi_{0.33}Co_{0.33}Mn_{0.33}O₂, LiNi_{0.5}Mn_{1.5}O₄, and LiCrMnO₄) and olivine type materials (for example, LiFePO₄). Among these, a lithium nickel cobalt manganese composite oxide having a layered structure which contains Li, Ni, Co, and Mn as constituent elements is preferable from the viewpoints of heat stability and energy density.

The positive electrode active material is typically particulate (powder-like). The average particle size is, for example, 0.1 μm or more, preferably 0.5 μm or more, and more preferably 5 μm or more and is, for example, 20 μm or less, preferably 15 μm or less, and more preferably 10 μm or less. In addition, the specific surface area is, for example, 0.1 m²/g or more and preferably 0.5 m²/g or more and is, for example, 20 m²/g or less, typically 10 m²/g or less, preferably 5 m²/g or less, and more preferably 2 m²/g or less. A positive electrode active material satisfying one or two among the above-described characteristics can maintain an appropriate porosity and superior conductivity in the positive electrode active material layer. Accordingly, during normal use, superior battery characteristics (for example, input and output characteristics) can be exhibited. In addition, even if a part of a surface of the positive electrode is covered with a film, a reaction field of a gas producing agent can be maintained. As a result, during overcharge, most parts of the gas producing agent can be rapidly and stably oxidized and decomposed to produce gas. Due to the produced gas, a CID can be rapidly operated. In this specification, “average particle size” refers to a particle size (also referred to as “D₅₀ particle size” or “median size”) corresponding to a cumulative value of 50 vol % in order from the smallest particle size in a volume particle size distribution based on a general laser diffraction scattering method. In this specification, “specific surface area” refers to a specific surface area (BET specific surface area) which is measured with a BET method (for example, a multi-point BET method) using nitrogen gas.

In addition to the positive electrode active material, the positive electrode active material layer may optionally contain one material or two or more materials which can be used as components of a positive electrode active material layer in a general nonaqueous electrolyte secondary battery. Examples of the material include a conductive material and a binder. Examples of the conductive material include carbon materials such as various carbon blacks (for example, acetylene black and Ketjen black), activated carbon, graphite, and carbon fiber which are preferably used. Examples of the binder, include vinyl halide resins such as polyvinylidene fluoride (PVdF); and polyalkylene oxides such as polyethylene oxide (PEO). In addition, the positive electrode active material layer may further contain various additives (for example, a dispersant or a thickener) within a range where the effects of the invention do not significantly deteriorate.

The average thickness of the positive electrode active material layer per single surface may be, for example, 20 μm or more (typically 40 μm or more, preferably 50 μm or more) and may be, for example, 100 μm or less (typically 80 μm or less). The porosity of the positive electrode active material layer may be, for example, 10 vol % to 50 vol % (typically 20 vol % to 40 vol %). The density of the positive electrode active material layer may be, for example, 1.5 g/cm³ or more (typically 2 g/cm³ or more) and may be, for example, 4 g/cm³ or less (typically 3.5 g/cm³ or less). By satisfying one or two or more among the above-described characteristics, battery performance (for example, high energy density or high input and output densities) and overcharge resistance can be simultaneously realized at a higher level. In this specification, “porosity” refers to a value which is obtained by dividing a total pore volume (cm³) by the apparent volume (cm³) of an active material layer and multiplying the divided value by 100, the total pore volume being obtained by measurement using a mercury porosimeter. In this specification, “density” refers to a value obtained by dividing the mass (g) of an active material layer by the apparent volume (cm³) thereof. The apparent volume can be calculated as the product of the area (cm²) in a plan view and the thickness (cm).

[Negative Electrode]

Typically, the negative electrode of the battery disclosed herein includes: a negative electrode current collector; and a negative electrode active material layer that contains a negative electrode active material attached to the negative electrode current collector. As the negative electrode current collector, a conductive member formed of highly conductive metal (for example, copper, nickel, titanium, or stainless steel) is preferable.

The negative electrode active material layer includes at least a negative electrode active material. As the negative electrode active material, one kind or two or more kinds may be used among various materials which can be used as a negative electrode active material of a nonaqueous electrolyte secondary battery. Preferable examples of the negative electrode active material include various carbon materials such as graphite, non-graphitizable carbon (hard carbon), graphitizable carbon (soft carbon), carbon nanotube, and a combination thereof. Among these, from the viewpoint of energy density, a graphite-based material containing 50 mass % or more of graphite with respect to the total mass of the negative electrode active material is preferable. The negative electrode active material is typically particulate (powder-like). The average particle size may be, for example, 20 μm or less, typically 0.5 μm to 15 μm, and preferably 1 μm to 10 μm. By satisfying the above-described characteristics, the reduction decomposition of the nonaqueous electrolyte, for example, in a high-temperature environment can be more efficiently suppressed, and the effects of the invention can be exhibited at a higher level.

In addition to the negative electrode active material, the negative electrode active material layer may optionally contain one material or two or more materials which can be used as components of a negative electrode active material layer in a general nonaqueous electrolyte secondary battery. Examples of the material include a binder and various additives. Examples of the binder include styrene-butadiene rubber (SBR), polyvinylidene fluoride (PVdF), and polytetrafluoroethylene (PTFE). Moreover, the negative electrode active material layer may further appropriately contain various additives such as a thickener, a dispersant, or a conductive material. Examples of the thickener include celluloses such as carboxymethyl cellulose (CMC) and methyl cellulose (MC).

<Separator>

The separator of the battery disclosed herein includes a hydrofluoric acid trapping layer containing an inorganic phosphate compound that is formed on a surface of the separator. In other words, the separator includes the hydrofluoric acid trapping layer so as to be in contact with the positive electrode active material layer and the negative electrode active material layer. In a typical example, the separator includes at least a separator substrate and a hydrofluoric acid trapping layer.

In a preferred aspect, the hydrofluoric acid trapping layer is directly attached to the surface of the separator substrate. The separator substrate may insulate the positive electrode and the negative electrode from each other and have a function of holding the nonaqueous electrolyte or a so-called shutdown function. Preferable examples of the separator include a porous resin sheet (film) formed of a resin such as polyethylene (PE), polypropylene (PP), polyester, cellulose, or polyamide. The porous resin sheet may have a single-layer structure or a multilayer structure including two or more layers (for example, a three-layer structure in which a PP layer is laminated on both surfaces of a PE layer; that is PP/PE/PP). The average thickness of the separator substrate may be, for example, 10 μm to 40 μm from the viewpoint of suppressing battery resistance to be low while stably exhibiting the above-described functions. In addition, the porosity of the separator substrate may be, for example, 20 vol % to 90 vol % (typically 30 vol % to 80 vol % and preferably 40 vol % to 60 vol %) from the viewpoints of simultaneously realizing the permeability of charge carrying ions and mechanical strength at a high level.

The hydrofluoric acid trapping layer contains at least an inorganic phosphate compound. As the inorganic phosphate compound, any compound containing at least one phosphate ion (PO₄³−) can be used without any particular limitation. Preferable examples of the inorganic phosphate compound include a known inorganic solid electrolyte material which can function as a solid electrolyte material of an all-solid-state battery. Specific examples of the inorganic phosphate compound include Li₃PO₄, LiPON (lithium phosphate oxynitride), LAGP (lithium aluminum geranium phosphate); a phosphoric acid-based lithium ion conductor such as Li_{1.5}A1_{0.5}Ge_{1.5} (PO₄)₃); and a NASICON type lithium ion conductor such as Li_{1.5}Al_{0.5}Ge_{1.5} (PO₄)₃). In the above-described example, the charge carrying ion is a lithium ion (Li) but may be other cations (typically, an alkali metal ion such as Na⁺ or K⁺), a Group 2 element ion such as Mg²⁺ or Ca²⁺ (typically, an alkali earth metal ion)). Among these, a phosphate containing an alkali metal element or a Group 2 element, for example, Li₃PO₄, Na₃PO₄, K₃PO₄, Mg₃(PO₄)₂, or Ca₃(PO₄)₂ is preferable due to its high hydrofluoric acid trapping ability. In particular, a compound (for example, lithium phosphate (for example, in a lithium ion secondary battery, lithium phosphate (Li₃PO₄) having the same cation as that of a supporting electrolyte described below is preferable.

The hydrofluoric acid trapping ability of the inorganic phosphate compound can be verified using the following method. First, the inorganic phosphate compound as an evaluation target is added to an hydrochloric acid aqueous solution adjusted to 0.01 mol/L (p≈2). Next, a change over time in the pH of the aqueous solution is measured under stirring. A compound having a value (ΔpH=pHₐ−pH_{b}) of 0.5 or more (preferably 1 or more and more preferably 3 or more) can be estimated to have high hydrofluoric acid trapping ability when the value is obtained by subtracting the pH (pH_{b}; here pH_{b}≈2) of the hydrochloric acid aqueous solution used from the pH (pHₐ) thereof after 60 minutes. For example, when the initial pH is adjusted to 2.0, the pH of a compound after 60 minutes is preferably 2.5 or higher (more preferably 3.0 or higher and still more preferably 5.0 or higher). The pH value refers to a value at a solution temperature of 25° C.

The characteristics of the inorganic phosphate compound are not particularly limited. However, from the viewpoint of securing a wide contact area with the nonaqueous electrolyte, the inorganic phosphate compound may be particulate (powder-like), and the average particle size thereof may be about 15 μm or less (typically 10 μm or less; for example, 5 μm or less). From the viewpoints of handleability during work and quality stability, the average particle size may be about 0.01 μm or more (typically 0.05 μm or more; for example, 1 μm or more). In the above-described particle size range, the effects of the invention can be exhibited at a higher level. In addition due to the same reason, the specific surface area of the inorganic phosphate compound may be about 5 m²/g to 50 m²/g (typically, 10 m²/g to 40 m²/g; for example 20 m²/g to 30 m²/g).

In addition to the above-described inorganic phosphate compound, optionally, the hydrofluoric acid trapping layer may further contain one material or two or more materials. Examples of the material include a binder and various additives. As the binder, for example, exemplary compounds which are described above as a constituent material of the positive electrode active material layer or the negative electrode active material layer can be considered. Specific examples of the binder include styrene-butadiene rubber (SBR), polyvinylidene fluoride (PVdF), and polytetrafluoroethylene (PTFE). Examples of the additives include an inorganic filler such as alumina, boehmite, silica, titania, calcia, magnesia, zirconia, boron nitride, or aluminum nitride can be preferably used.

The addition amount of the inorganic phosphate compound may vary depending on, for example, the kind and characteristics (for example, average particle size or specific surface area) of the positive electrode active material. However, in a preferred example, the addition amount of the inorganic phosphate compound may be about 0.1 parts by mass or more (typically 0.5 parts by mass or more and preferably 1 parts by mass or more; for example, 2 parts by mass or more) with respect to 100 parts by mass of the positive electrode active material from the viewpoint of sufficiently obtaining the effects of the invention. In another preferred embodiment, the addition amount of the inorganic phosphate compound may be about 8 parts by mass or less (preferably 5 parts by mass or less; for example, 4 parts by mass or less) with respect to 100 parts by mass of the positive electrode active material from the viewpoint of reducing battery resistance. A ratio of the mass of the inorganic phosphate compound to the total mass of the hydrofluoric acid trapping layer is suitably about 50 mass % or more and is usually preferably about 70 mass % to 99 mass % (for example, 85 mass % to 95 mass %). When the binder is used, a ratio of the mass of the binder to the total mass of the hydrofluoric acid trapping layer is, for example, about 1 mass % to 30 mass % and is usually preferably about 1 mass % to 20 mass %.

A method of preparing the separator having the above-described aspect is not particularly limited. For example, first, the inorganic phosphate compound and optionally used materials are dispersed in an appropriate solvent to prepare a paste-like or slurry-like composition (slurry for forming the hydrofluoric acid trapping layer). The surface of the separator substrate is coated with this slurry using an arbitrary method and dried. As a result, a separator including the hydrofluoric acid trapping layer that is formed on the surface of the separator substrate can be prepared. As the solvent, either an aqueous solvent or an organic solvent can be used. For example, N-methyl-2-pyrrolidone (NMP) can be used. In addition, the coating of the slurry can be performed using an appropriate coater such as a gravure coater, a slid coater, a die coater, a comma coater, or a dip coater. Alternatively, the coating of the slurry can be performed using means such as spray coating. In addition, the drying can be performed using general drying means (for example, drying by heating or vacuum drying).

The separator of the battery disclosed herein may include the hydrofluoric acid trapping layer on only a single surface or both surfaces of the separator substrate. From the viewpoint of reducing battery resistance, the aspect of including the hydrofluoric acid trapping layer on only the single surface can be preferably adopted. In addition, when the positive electrode and the negative electrode are disposed to be opposite with the separator interposed therebetween, the hydrofluoric acid trapping layer may be opposite the positive electrode, may be opposite the negative electrode, or may be opposite both the positive electrode and the negative electrode. In a preferred embodiment, the separator includes the hydrofluoric acid trapping layer that is formed on a surface on a side opposite at least the positive electrode. In a case where the hydrofluoric acid trapping layer is continuously in contact with the positive electrode, when the inorganic phosphate compound is a compound (for example, the above-described inorganic solid electrolyte material) having ion conductivity, the potential of not only the positive electrode but also the hydrofluoric acid trapping layer can be increased due to the charging of the battery. According to the investigation by the present inventors, when the potentials of the hydrofluoric acid trapping layer are about 3.0 V or higher (vs. Li/Li⁺), the hydrofluoric acid trapping ability of the hydrofluoric acid trapping layer (specifically, the inorganic phosphate compound) can be exhibited at a higher level. Alternatively, by increasing the potential of the hydrofluoric acid trapping layer, the potential of the positive electrode decreases, and the oxidation decomposition of the nonaqueous electrolyte on the positive electrode can be suppressed. Accordingly, the effects of the invention can be exhibited at a higher level. For example, battery characteristics (for example, durability) during normal use can be improved, or durability during overcharge can be improved.

In a preferred aspect, the separator may have a configuration in which a porous heat resistance layer and the hydrofluoric acid trapping layer are laminated on the surface of the separator substrate in this order. In other words, the separator may have a configuration in which the hydrofluoric acid trapping layer is indirectly provided on the surface of the separator substrate. The porous heat resistance layer may be a layer containing the inorganic filler and the binder which are described above as the examples of the constituent material of the hydrofluoric acid trapping layer. Alternatively, the porous heat resistance layer may be a layer containing insulating resin particles (for example, particles of polyethylene, polypropylene, or the like) and the binder. Regarding the hydrofluoric acid trapping layer, the same description as above can be applied.

<Nonaqueous Electrolyte>

The nonaqueous electrolyte of the battery disclosed herein contains at least a fluorine-containing compound and a gas producing agent. The nonaqueous electrolyte may contain the fluorine-containing compound as, for example, a supporting electrolyte and/or a nonaqueous solvent. The nonaqueous electrolyte is typically liquid (that is, a nonaqueous electrolytic solution) at an ordinary temperature (for example, 25° C.). For example, the nonaqueous electrolyte may be liquid all the time in an operating environment of the battery (for example, in a temperature environment of −30° C. to 70° C.).

In a preferred aspect, (1) a nonaqueous solvent not containing fluorine (non-fluorine-based nonaqueous solvent) contains at least (2) a fluorine-containing compound, as a supporting electrolyte, and (3) a gas producing agent. (1) As the non-fluorine-based nonaqueous solvent, a solvent which can be used in a general nonaqueous electrolyte secondary battery can be adopted without any particular limitation. Typical examples of the non-fluorine-based nonaqueous solvent include aprotic solvents such as carbonates, esters, ethers, nitriles, sulfones, and lactones. Among these nonaqueous solvents, one kind can be used alone, or two or more kinds can be appropriately used in combination. Preferable examples of the nonaqueous solvent include carbonates such as ethylene carbonate (EC), propylene carbonate (PC), diethyl carbonate (DEC), dimethyl carbonate (DMC), and ethyl methyl carbonate (EMC).

(2) As the fluorine-containing compound which is the supporting electrolyte, any compound which can be used in a general nonaqueous electrolyte secondary battery can be appropriately adopted as long as it contains a charge carrying ion (for example, Li⁺, Na⁺, or Mg²⁺; in a lithium ion secondary battery, Li+) and a fluoride ion (F−). For example, when the charge carrying ion is Li⁺, examples of the fluorine-containing compound include LiPF₆, LiBF₄, LiAsF₆, LiN(SO₂CF₃)₂, LiN(SO₂C₂F₅)₂, LiCF₃SO₃, LiC₄F₉SO₃, and LiC(SO₂CF₃)₃. Among these, LiPF₆ is preferable. Among these supporting electrolytes, one kind can be used alone, or two or more kinds can be used in combination. In addition, the concentration of the supporting electrolyte may be about 0.8 mol/L to 1.5 mol/L from the viewpoint of maintaining and improving the ion conductivity and reducing the charge transfer resistance.

(3) As the gas producing agent, any compound can be adopted without any particular limitation as long as it decomposes to produce gas at higher than a predetermined battery voltage (that is, when the oxidation potential (vs. Li/Li⁺) is higher than the charging upper limit potential of the positive electrode, and when the battery is overcharged to higher than the potential, the compound can be oxidized and decomposed to produce hydrogen gas). Specific examples of this compound include a compound having a biphenyl structure such as biphenyl or alkylbiphenyl, alkylbenzene, cycloalkylbenzene, an organic phosphorus compound, a cyclic carbamate, and an alicyclic hydrocarbon. Among these gas producing agents, one kind can be used alone, or two or more kinds can be used in combination. For example, in a battery in which the charging upper limit potential (vs. Li/Li⁺) of the positive electrode is set to be about 4.0 V to 4.3 V, biphenyl (BP) having an oxidation potential of about 4.5 V (vs. Li/Li⁺) or cyclohexylbenzene (CHB) having an oxidation potential of about 4.6 V (vs. Li/Li⁺) can be preferably adopted. These gas producing agents have an oxidation potential close to the charging upper limit potential of the positive electrode, and thus can be oxidized and decomposed in an extremely initial stage of overcharge so as to rapidly produce hydrogen gas. Accordingly, the reliability during overcharge can be further improved.

The addition amount of the gas producing agent in the nonaqueous electrolytic is not particularly limited, but may be suitably about 1 mass % or more (preferably, 2 mass % or more; for example, 3 mass % or more) with respect to 100 mass % of the nonaqueous electrolyte from the viewpoint of securing a sufficient amount of gas for operating the CID. However, the gas producing agent may function as a resistance component in a cell reaction. Therefore, when an excess amount of the gas producing agent is added, input and output characteristics may deteriorate. In addition, for example, when the battery is exposed to a high-temperature environment, the CID may malfunction. From this point of view, the addition amount of the gas producing agent is about 7 mass % or less, preferably 5 mass % or less, and more preferably 4 mass % or less with respect to 100 mass % of the nonaqueous electrolyte.

In the above-described preferred aspect, the fluorine-containing compound is contained as the supporting electrolyte, but the invention is not limited to the embodiment. For example, a nonaqueous solvent containing fluorine (fluorine-based) nonaqueous solvent may contain a fluorine-based supporting electrolyte or non-fluorine-based supporting electrolyte and the gas producing agent. As the fluorine-based nonaqueous solvent, a solvent having a chemical structure can be adopted in which at least one hydrogen atom constituting the above-described non-fluorine-based nonaqueous solvent is substituted with a fluorine atom. Specific examples of the fluorine-based nonaqueous solvent include fluorinated cyclic carbonates such as monofluoroethylene carbonate (MFEC) and difluoroethylene carbonate (DFEC); and fluorinated chain carbonates such as fluoromethyl methyl carbonate and trifluoro dimethyl carbonate (TFDMC). Examples of the non-fluorine-based supporting electrolyte include LiClO₄ and LiI.

In addition to the above-described components, optionally the nonaqueous electrolyte may further contain various additives within a range where the objects of the invention do not significantly deteriorate. These additives are used for one or two or more of the purposes including: improvement of the storability of the battery; improvement of input and output characteristics; improvement of cycle characteristics; and improvement of an initial charge-discharge efficiency. Specific examples of the additives include fluorophosphates (typically, difluorophosphates; for example, lithium difluorophosphate), lithium bis(oxalato)borate (Li[B(C₂O₄)₂]), vinylene carbonate (VC), and fluoroethylene carbonate (FEC).

<Battery Case>

The battery case is a container that accommodates the electrode body and the nonaqueous electrolyte. As a material of the battery case, a relatively light-weight metal (for example, aluminum or an aluminum alloy) is preferable from the viewpoint of, for example, improving heat dissipation and energy density. The shape of the battery case (the external shape of the container) is, for example, a hexahedron shape (a rectangular shape or a cube shape), a circular shape (a cylindrical shape, a coin shape, or a button shape), a bag shape, and a shape obtained by processing and modifying the above-described shape. In addition the battery case of the battery disclosed herein includes a pressure-operated current interrupt device (CID) that forcedly interrupts a charging current when the internal pressure of the battery case is a predetermined value or higher.

According to the investigation by the present inventors, in the battery in which the nonaqueous electrolyte contains the fluorine-containing compound, when being exposed to severe conditions (for example, a high-temperature environment), the fluorine-containing compound may be gradually decomposed (for example, may be reduced and decomposed on the negative electrode) to produce hydrofluoric acid (HF) More specifically, for example, under severe conditions, LiPF₆ as the supporting electrolyte contained in the nonaqueous electrolyte and a very small amount of water, which may be contained in the battery, cause a reaction (hydrolysis reaction) shown in the following formulae (S1,S2), which may accelerate the production of hydrofluoric acid.

LiPF₆→LiF+PF₅ (S1)

PF₅+H₂O→POF₃+2HF (S2)

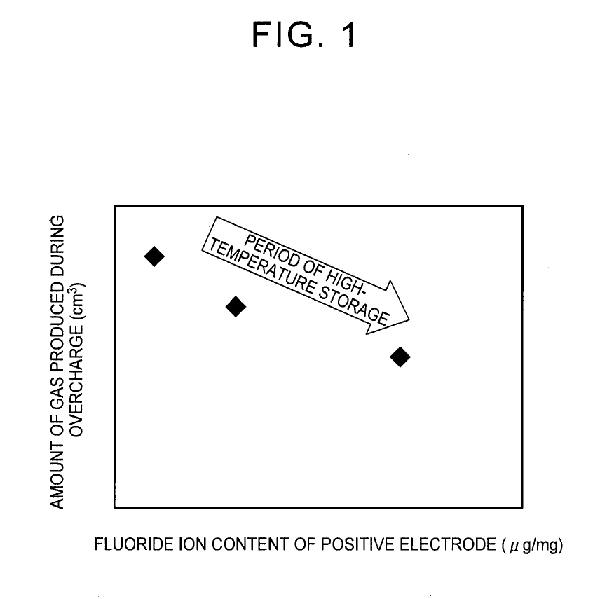

The hydrofluoric acid (when being ionized in the nonaqueous electrolyte, which may be in the form of a fluoride ion (F−)) may be electrically attracted to the positive electrode side and may be deposited (crystallized) on the surface of the positive electrode as a film containing fluorine. As a result, in the battery exposed to severe conditions (after endurance), the production of gas during overcharge may be slowed, or the amount of gas produced may relatively decrease. For example, FIG. 1 shows a relationship between the amount of gas produced during overcharge and the fluoride ion content of a positive electrode, after a predetermined period of storage in a high-temperature environment of 60° C. As can be clearly seen from FIG. 1, a negative proportional relationship is established between the amount of gas produced during overcharge and the fluoride ion content of a positive electrode. That is, as a period (endurance period) where the battery is exposed to a high-temperature environment of 60° C. increases, the fluoride ion content of the positive electrode in the battery after the endurance tends to increase. As the endurance period increases, the amount of gas produced during overcharge tends to decrease in the battery after the endurance. A method of measuring the amount of gas produced during overcharge and the fluoride ion content will be described in more detail in Examples.

However, in the battery disclosed herein including the separator in which the hydrofluoric acid trapping layer is provided, for example, due to a reaction shown in the following formula (S3), hydrofluoric acid produced during the endurance can be trapped (caught or consumed) by the inorganic phosphate compound.

H⁺+HF+PO₄³−→PO₃F²⁻+H₂O (S3)

As a result, the formation of a fluorine-containing film on the surface of the positive electrode can be suppressed. In other words, even after the battery is exposed to severe conditions (for example, a high-temperature environment of 50° C. or higher) for a long period of time, the reaction field of the gas producing agent (the contact area between the gas producing agent and the surface of the positive electrode) can be maintained to be wide. Accordingly, when the battery is overcharged, the gas producing agent can be caused to stably react (oxidation polymerization) on the positive electrode. Due to gas produced from the positive electrode, the CID can be rapidly and stably operated. As a result, a nonaqueous electrolyte secondary battery having improved overcharge resistance after endurance can be realized.

According to the investigation by the present inventors, for example, in a structure where a hydrofluoric acid trapping layer is provided on a surface of a positive electrode active material layer, it is difficult to stably realize the above-described effect. This mechanism is not clear, but it is presumed to be that, for example, the contact area between the active material layer and the hydrofluoric acid trapping layer may have an influence on the hydrofluoric acid trapping ability of the inorganic phosphate compound. That is, in the configuration where the hydrofluoric acid trapping layer is provided on the surface of the positive electrode active material layer, when the positive electrode active material layer is repeatedly expanded and shrunk by charging and discharging, peeling may occur at an interface between the positive electrode active material layer and the hydrofluoric acid trapping layer. Alternatively, the inorganic phosphate compound is slowly consumed due to a reaction with hydrofluoric acid, and the contact area between the positive electrode active material layer and the hydrofluoric acid trapping layer may be gradually reduced. As a result, it is considered that the hydrofluoric acid trapping ability of the inorganic phosphate compound may decrease. On the other hand, in the configuration of the battery disclosed herein (the configuration in which the hydrofluoric acid trapping layer is provided on the surface of the separator), the state where the active material layer and the hydrofluoric acid trapping layer are in contact with each other can be continuously maintained. That is, it is considered that the configuration disclosed herein in which the hydrofluoric acid trapping layer is provided on the surface of the separator is efficient from the viewpoint of improving overcharge resistance.

<One Embodiment of Nonaqueous Electrolyte Secondary Battery>

Although it is not intended to limit the invention, a nonaqueous electrolyte secondary battery according to an embodiment of the invention in which a wound electrode body and a nonaqueous electrolytic are accommodated in a flat rectangular (box-shaped) battery case will be described as an example. In addition, in the following drawings, parts or portions having the same function are represented by the same reference numerals, and the repeated description will not be made or will be simplified. In each drawing, a dimensional relationship (for example, length, width, or thickness) does not necessarily reflect the actual dimensional relationship.

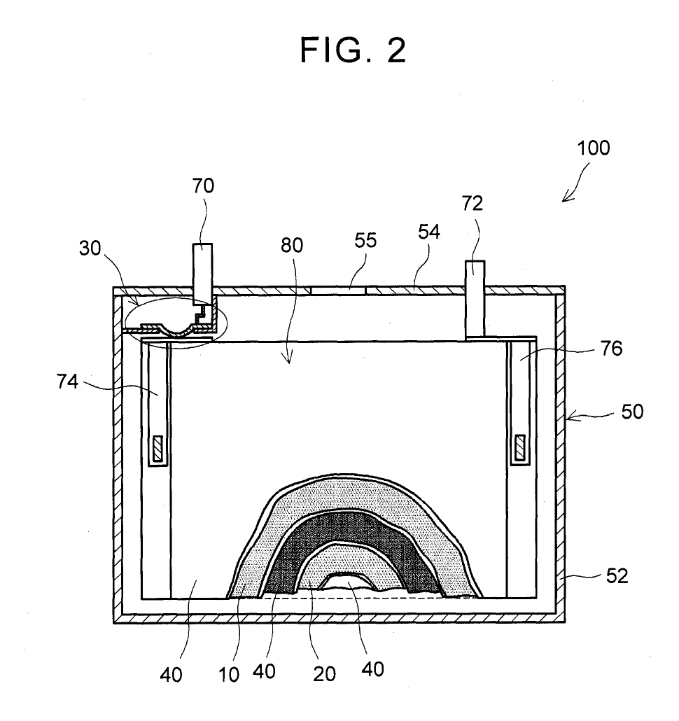

FIG. 2 is an exploded cross-sectional view schematically showing a cross-sectional structure of a nonaqueous electrolyte secondary battery 100 according to the embodiment of the invention. In this nonaqueous electrolyte secondary battery 100, an electrode body (wound electrode body) 80 and a nonaqueous electrolytic (not shown) are accommodated in a flat box-shaped battery case 50, the electrode body 80 having a configuration in which an elongated positive electrode sheet 10 and an elongated negative electrode sheet 20 are wound flat with an elongated separator sheet 40 interposed therebetween.

The battery case 50 includes: a flat rectangular battery case body 52 having an open upper end; and a lid 54 that covers the opening. In a top surface (that is, the lid 54) of the battery case 50, a positive electrode terminal 70 for external connection, which is electrically connected to the positive electrode of the wound electrode body 80, and a negative electrode terminal 72, which is electrically connected to the negative electrode of the wound electrode body 80, are provided. As in the case of a battery case of a nonaqueous electrolyte secondary battery in the related art, the lid 54 further includes a safety valve 55 for discharging gas, produced from the inside of the battery case 50, to the outside of the battery case 50. Further, in the battery case 50, a current interrupt device 30 that is operated due to an increase in the internal pressure of the battery case 50 is provided between the positive electrode terminal 70, fixed to the lid 54, and the wound electrode body 80. When the internal pressure of the battery case 50 increases, the current interrupt device 30 is configured to interrupt a charging current by disconnecting a conductive path ranging from at least one of the electrode terminals (that is, the positive electrode terminal 70 and/or the negative electrode terminal 72) to the wound electrode body 80. In this embodiment, when the internal pressure of the battery case 50 increases, the current interrupt device 30 is configured to disconnect a conductive path ranging from the positive electrode terminal 70 to the wound electrode body 80.

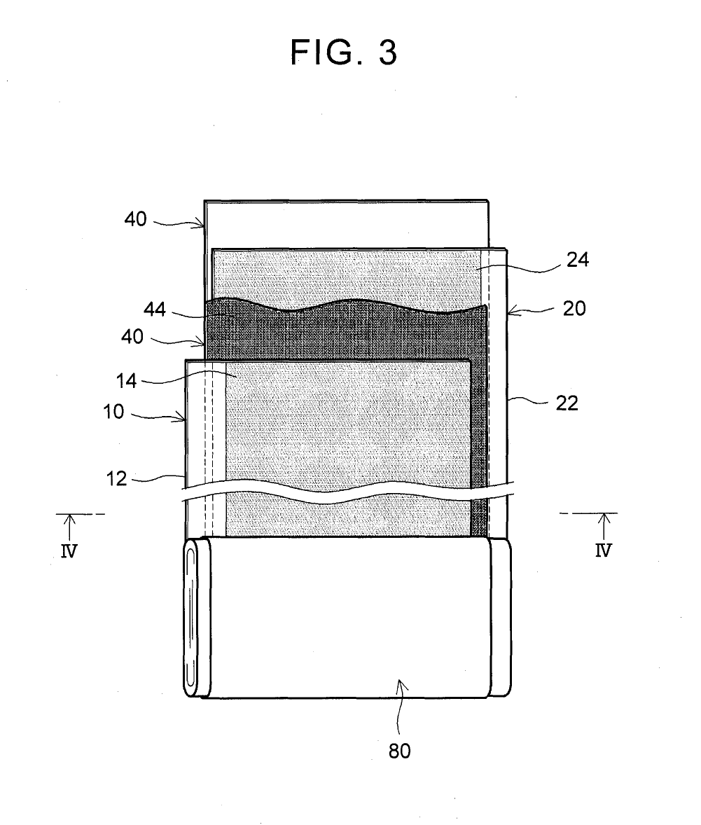

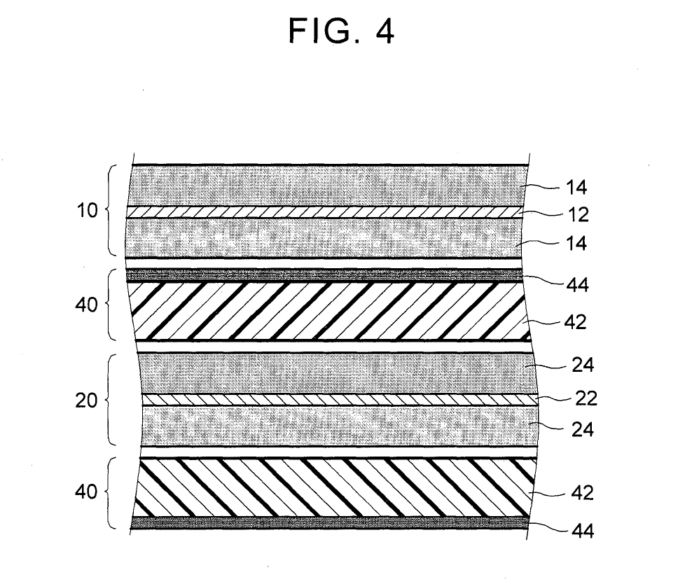

FIG. 3 is a schematic diagram showing a configuration of the flat wound electrode body 80 shown in FIG. 2. FIG. 4 is a schematic diagram showing a cross-sectional structure of the wound electrode body 80 taken along IV-IV line of FIG. 3. In FIG. 4, spaces are provided between the respective components for easy understanding. However, in the actual battery, generally, the components are disposed such that the respective components opposite to each other (positive electrode sheet 10/separator sheet 40/negative electrode sheet 20) are in contact with each other. As shown in FIGS. 3 and 4, this wound electrode body 80 has an elongated sheet structure (sheet-shaped electrode body) in a step before the assembly of the wound electrode body 80. The positive electrode sheet 10 includes an elongated positive electrode current collector 12; and a positive electrode active material layer 14 that is formed on at least one surface (here, on both surfaces) in a longitudinal direction. The negative electrode sheet 20 includes an elongated negative electrode current collector 22; and a negative electrode active material layer 24 that is formed on at least one surface (here, on both surfaces) in a longitudinal direction. In addition, two separators (separator sheets) 40 having an elongated sheet shape are arranged between the positive electrode active material layer 14 and the negative electrode active material layer 24 as an insulating layer for preventing direct contact therebetween. The separator sheet 40 includes an elongated separator substrate 42; and a hydrofluoric acid trapping layer 44 that is formed on at least one surface (typically, on a single surfaces) in a longitudinal direction.

At the center of the wound electrode body 80 in the winding axial direction, a winding core portion (that is, a portion in which the positive electrode sheet 10, the negative electrode sheet 20, and the separator sheets 40 are densely laminated) is provided. In addition, at opposite end portions of the wound electrode body 80 in the winding axial direction, a part of electrode active material layer non-forming portions (current collector exposure portions) of the positive electrode sheet 10 and the negative electrode sheet 20 protrude from the winding core portion to the outside, respectively. In the protrusion on the positive electrode side and the protrusion on the negative electrode side, a positive electrode current collector plate 74 and a negative electrode current collector plate 76 are provided and are electrically connected to the positive electrode terminal 70 (FIG. 2) and the negative electrode terminal 72 (FIG. 2).

<Use of Nonaqueous Electrolyte Secondary Battery>

The nonaqueous electrolyte secondary battery (for example, a lithium ion secondary battery) disclosed herein can be used in various applications, but is characterized in that overcharge resistance is high even after being exposed to a severe environment such as a high-temperature environment (for example, under intense sun) for a long period of time. In a preferred aspect, the nonaqueous electrolyte secondary battery is characterized in that battery resistance is suppressed, and superior input and output characteristics can be exhibited for a long period of time even during normal use. Accordingly, the nonaqueous electrolyte secondary battery can be preferably used, for example, in applications in which a storage or operating environment may be at a high temperature, in applications in which high reliability is required, and in applications in which high input and output densities are required. Examples of the applications include a power source (driving power supply) for a vehicle-mounted motor. The type of the vehicle is not particularly limited, and examples thereof include a plug-in hybrid vehicle (PHV), a hybrid vehicle (HV), an electric vehicle (EV), an electric truck, an electric scooter, an electric-assisted bicycle, an electric wheelchair, and an electric railway. This nonaqueous electrolyte secondary battery may be used in the form of a battery pack in which plural secondary batteries are connected to each other in series and/or in parallel.

Hereinafter, several examples relating to the invention will be described, but the specific examples are not intended to limit the invention.

[I. Verification of Effect of Hydrofluoric Acid Trapping Layer]

### EXAMPLE 1

### Case Where Hydrofluoric Acid Trapping Layer was not Provided

First, Li[Ni_{0.33}Co_{0.33}Mn_{0.33}]O₂ powder (NCM, average particle size: 6 μm, specific surface area: 0.7 m²/g) as a positive electrode active material; polyvinylidene fluoride (PVdF) as a binder; and acetylene black (AB) as a conductive material were weighed such that a mass ratio (NCM:PVdF:AB) of the materials was 91:3:6. The weighed materials were kneaded while adjusting the viscosity using N-methylpyrrolidone (NMP) to prepare a slurry for forming a positive electrode active material layer. A surface of an elongated aluminum foil (positive electrode current collector) having an average thickness of 15 μm was coated with this slurry in a belt shape and dried. As a result, a positive electrode active material layer was formed. The laminate was rolled using a roll press machine to adjust characteristics. In the configuration where the positive electrode active material layer was formed on both surfaces of the positive electrode current collector, the porosity of the positive electrode active material layer after the rolling was 32 vol %, and the density thereof was 2.8 g/cm³. In this way, a positive electrode sheet was prepared.

Next, natural graphite powder (C, average particle size: 5 μm, specific surface area: 3 m²/g) as a negative electrode active material; styrene-butadiene rubber (SBR) as a binder; and carboxymethyl cellulose (CMC) as a thickener were weighed such that a mass ratio (C:SBR:CMC) of the materials was 98:1:1. The weighed materials were kneaded while adjusting the viscosity with ion exchange water. As a result, a slurry for forming a negative electrode active material layer was prepared. A surface of an elongated copper foil (negative electrode current collector) having an average thickness of 10 μm was coated with the slurry in a belt shape and was dried. As a result, a negative electrode active material layer was formed. The laminate was rolled using a roll press machine to adjust characteristics. In the configuration where the negative electrode active material layer was formed on both surfaces of the negative electrode current collector, the porosity of the negative electrode active material layer after the rolling was 42 vol %, and the density thereof was 1.3 g/cm³. In this way, a negative electrode sheet was prepared.

Next, as a separator substrate, a substrate (PP/PE/PP, average thickness: 20 μm) having a three-layer structure in which a polypropylene (PP) layer was laminated on both surfaces of a polyethylene (PE) layer was used. The positive electrode sheet and the negative electrode sheet were disposed to be opposite each other with the separator substrate interposed therebetween. As a result, an electrode body was prepared. A positive electrode terminal and a negative electrode terminal were welded to the positive electrode current collector and the negative electrode current collector which were exposed through end portions of the electrode body. Next, this electrode body was disposed inside a laminate battery case having a bag shape. A nonaqueous electrolytic solution was injected into the battery case, and the battery case was sealed. As a result, a lithium ion secondary battery (laminate cell) of Example 1 was constructed. In order to prepare the nonaqueous electrolytic solution, LiPF₆ as a supporting electrolyte was dissolved in a mixed solvent at a concentration of 1.0 mol/L, the mixed solvent containing ethylene carbonate (EC), dimethyl carbonate (DMC), and ethyl methyl carbonate (EMC) at a volume ratio (EC:DMC:EMC) of 3:4:3. In addition, 2 mass % of cyclohexylbenzene (CHB) and 2 mass % of biphenyl (BP) with respect to the total mass (100 mass %) of the nonaqueous electrolytic solution were further dissolved in the mixed solvent. As a result, the nonaqueous electrolytic solution was prepared.

### EXAMPLE 2

### Case Where Hydrofluoric Acid Trapping Layer was Provided

In Example 2, the separator had a configuration in which a hydrofluoric acid trapping layer was provided on the surface of the separator substrate. That is, first, Li₃PO₄ as an inorganic phosphate compound was weighed such that the amount thereof was 1 part by mass with respect to 100 parts by mass of the positive electrode active material. This Li₃PO₄ was mixed with polyvinylidene fluoride (PVdF) as a binder in N-methylpyrrolidone (NMP) such that a mass ratio of the materials was 90:10. As a result, a slurry for forming a hydrofluoric acid trapping layer was prepared. A single surface of the separator substrate (PP/PE/PP) was coated with the slurry and dried. As a result, a hydrofluoric acid trapping layer was formed on the surface. In this way, the separator including the hydrofluoric acid trapping layer on the single surface of the separator substrate was prepared. A lithium ion secondary battery (laminate cell) of Example 2 was constructed using the same method as that of Example 1, except that the above-described separator was used.

<Measurement of Initial Characteristics>

### Initial Capacity

In a temperature environment of 25° C., the constructed laminate cell was charged and discharged according to the following operations (1) to (4) in a voltage range of 3.0 V to 4.2 V to check the initial capacity. (1) The battery was charged at a constant current (CC charging) at a rate of 0.2 C until the voltage reached 4.2 V. Next, the battery was charged at a constant voltage (CV charging) until the current reached a rate of 0.01 C. (2) The operation was stopped for 1 hour. (3) The battery was discharged at a constant current (CC discharging) at a rate of 0.2 C until the voltage reached 3.0 V. (4) The operation was stopped for 5 minutes. The discharge capacity during the CC charging was calculated to verify whether or not the constructed laminate cell had a defect.

### Initial Resistance

In a temperature environment of 25° C., the laminate cell was adjusted to SOC 60% and underwent CC discharging at a current of 160 mA (a rate of 10 C) for 10 seconds. The voltage drop amount at this time was divided by the current value to obtain a resistance value R.

<High-Temperature Storage Test>

In a temperature environment of 25° C., the laminate cell was adjusted to SOC 60% and was stored (left to stand) in a thermostatic chamber at 60° C. for 100 days. After 100 days, the laminate cell was extracted from the thermostatic chamber, and (I. Overcharge Test), (II. Resistance Measurement), and (III. Measurement of Fluoride Ion Content of Positive Electrode) were performed. The details of the measurements are as follows. (I. Overcharge Test (Measurement of Amount of Gas Produced)

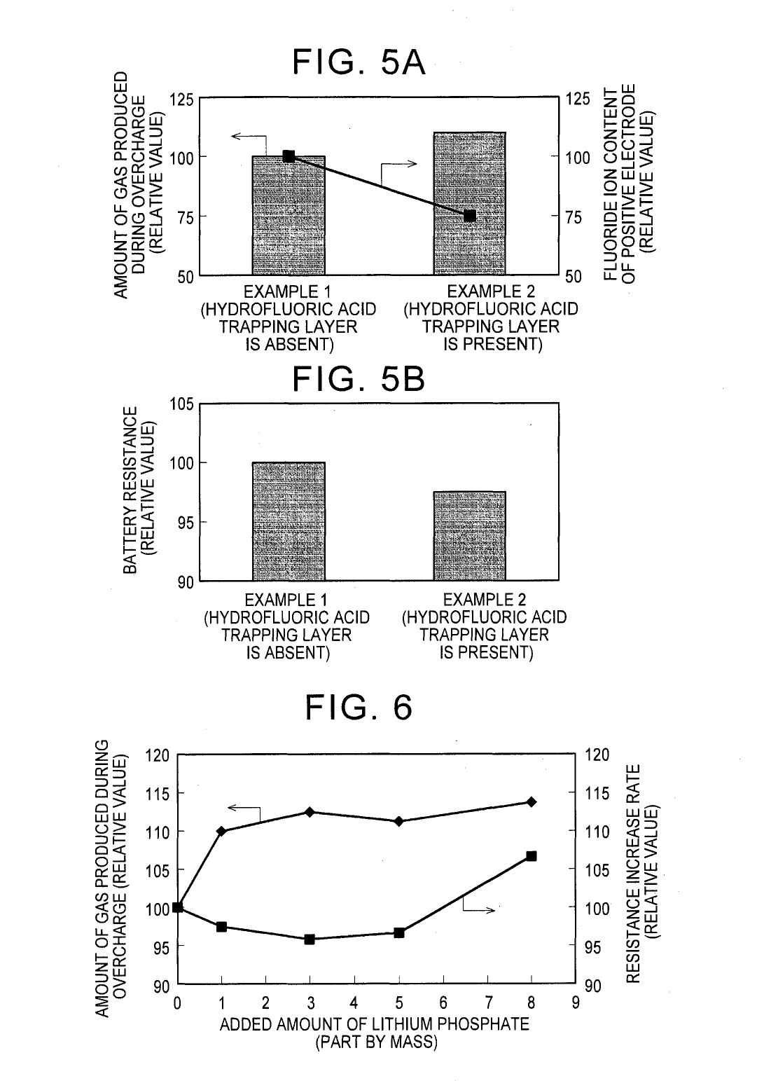

The amount of gas produced was measured using the Archimedes method. That is, first, after the high-temperature storage, the laminate cell was dipped in a container filled with fluorine-based inert liquid (FLUORINERT, manufactured by Sumitomo 3M Co. Ltd.). The volume A (cm3) of the cell was measured based on a weight change before and after the dipping. Next, under a temperature condition of 25° C., the battery underwent CC charging at a rate of 1 C until the battery was overcharged to SOC 120%. Next, the volume B (cm³) of the overcharged cell was measured using the same method as above. The amount of gas produced(=B−A (cm³)) was calculated by subtracting the volume A before the overcharge from the volume B after the overcharge. The results are shown in FIG. 5A. FIG. 5A shows a relative value when the amount of gas produced of Example 1 was set as a reference (100). (II. Measurement of Output Retention)

In a temperature environment of 25° C., the resistance value R after the high-temperature storage was measured using the same method as that of the initial characteristics. The results are shown in FIG. 5B. FIG. 5B shows a relative value when the resistance value R after the high-temperature storage of Example 1 was set as a reference (100). (III. Measurement of Fluoride Ion Content of Positive Electrode)

Using ion chromatography (IC), a film formed on the surface of the positive electrode was qualitatively and quantitatively analyzed. Specifically, first, the laminate cell after the high-temperature storage was disassembled. Next, the positive electrode (positive electrode active material layer) was cut out from the laminate cell and was washed with an appropriate solvent (for example, EMC). This positive electrode (measurement sample) was dipped in a 50% acetonitrile aqueous solution for about 30 minutes. As a result, a film component was extracted in the solvent. This solution was measured by ion chromatography to quantitatively analyze fluoride ions (F⁻). The obtained quantitative value (μg) was divided by the mass (mg) of the positive electrode active material layer provided for the measurement to obtain the fluoride ion content (μg/mg) of the positive electrode active material layer per unit mass. The results are shown in FIG. 5A. FIG. 5A shows a relative value when the fluoride ion content (μg/mg) of Example 1 was set as a reference (100).

As clearly seen from FIG. 5A, in Example 2 in which the hydrofluoric acid trapping layer was provided on the separator, the fluoride ion content of the positive electrode was reduced by about 25% as compared to Example 1 including no hydrofluoric acid trapping layer. In addition, in Example 2, when the battery was overcharged after being exposed to a high-temperature environment for a long period of time, the amount of gas produced was increased by about 10% as compared to that of Example 1. That is, in Example 2 according to the invention, the overcharge resistance of the battery after being exposed to a severe environment for a long period of time (after high-temperature storage) was improved. The reason is considered to be that, since the formation of the fluorine-containing film on the surface of the positive electrode was suppressed, the contact area between the gas producing agent and the surface of the positive electrode was able to be widely secured. Further, as shown in FIG. 5B, it was found that, in Example 2, overcharge resistance was improved, and battery resistance was also able to be relatively suppressed (maintained to be low).

[II. Investigation of Addition Amount of Inorganic Phosphate Compound]

In order to investigate a preferable addition amount of the inorganic phosphate compound, laminate cells were constructed using the same method as that of Example 2, except that Li₃PO₄ contained in the hydrofluoric acid trapping layer was weighed such that the amount thereof was 3 parts by mass (Example 3), 5 parts by mass (Example 4), and 8 parts (Example 5) by mass (Example 5) with respect to 100 parts by mass of the positive electrode active material. After the high-temperature storage test, (I. Overcharge Test (Measurement of Amount of Gas Produced)) and (II′ Resistance Measurement) were measured. The respective measurements were performed using the same method as that of the above-described “I.”. Regarding (II′), the resistance before the high-temperature storage was subtracted from the resistance after the high-temperature storage, was divided by the resistance before the high-temperature storage, and was multiplied by 100 to calculate a resistance increase. The results are shown in FIG. 6. FIG. 6 shows a relative value when the results of Example 1 were set as a reference (100).

As clearly seen from FIG. 6, when the addition amount of the inorganic phosphate compound was 1 part by mass or more with respect to 100 parts by mass of the positive electrode active material, the amount of gas produced during overcharge is significantly increased (by 10% or more as compared to Example 1), and the effects of the invention can be exhibited at a high level. In addition, when the addition amount of the inorganic phosphate compound is 5 parts by mass or less with respect to 100 parts by mass of the positive electrode active material, battery resistance can be further reduced. In particular, when the addition amount of the inorganic phosphate compound is 1 part by mass to 5 parts by mass (preferably 3 parts by mass±1 part by mass) with respect to 100 parts by mass of the positive electrode active material, battery characteristics during normal use and overcharge resistance (reliability) can be simultaneously realized at an extremely high level.

Hereinabove, the invention has been described in detail, but the above-described embodiments are merely exemplary. The invention disclosed herein includes various modifications and alternations of the above-described specific examples.

I what is claimed is:

1. A nonaqueous electrolyte secondary battery comprising:
an electrode body in which a positive electrode and a negative electrode are disposed to be opposite to each other with a separator interposed between the positive electrode and the negative electrode;
a nonaqueous electrolyte; and
a battery case that accommodates the electrode body and the nonaqueous electrolyte, wherein
the battery case includes a current interrupt device that operates in response to an increase in an internal pressure of the battery case,
the nonaqueous electrolyte contains a fluorine-containing compound and a gas producing agent, and
the separator includes a hydrofluoric acid trapping layer containing an inorganic phosphate compound on a surface of the separator.

2. The nonaqueous electrolyte secondary battery according to claim 1, wherein
the separator includes the hydrofluoric acid trapping layer on a surface on a side opposite the positive electrode.

3. The nonaqueous electrolyte secondary battery according to claim 1, wherein
in the separator, a porous heat resistance layer is laminated on a surface of a separator substrate, and the hydrofluoric acid trapping layer is laminated on a surface of the porous heat resistance layer.

4. The nonaqueous electrolyte secondary battery according to claim 1, wherein
a ratio of a mass of the inorganic phosphate compound to total mass of the hydrofluoric acid trapping layer is 70 mass % to 99 mass %.

5. The nonaqueous electrolyte secondary battery according to claim 1, wherein
a ratio of a mass of a binder to total mass of the hydrofluoric acid trapping layer is 1 mass % to 20 mass %.

6. The nonaqueous electrolyte secondary battery according to claim 1, wherein
the positive electrode contains a positive electrode active material, and
a content of the inorganic phosphate compound is 1 part by mass or more with respect to 100 parts by mass of a mass of the positive electrode active material.

7. The nonaqueous electrolyte secondary battery according to claim 6, wherein
the content of the inorganic phosphate compound is 5 parts by mass or less with respect to 100 parts by mass of the mass of the positive electrode active material.

8. The nonaqueous electrolyte secondary battery according to claim 1, wherein
the inorganic phosphate compound contains Li₃PO₄.

9. The nonaqueous electrolyte secondary battery according to claim 1, wherein
an average particle size of the inorganic phosphate compound is 10 μm or less.
